(19) United States
(12) Patent Application Publication
(10) Pub. No.: US 2024/0341308 A1
(43) Pub. Date: Oct. 17, 2024

(54) TEXTURIZED INSECTICIDAL FORMULATION

(71) Applicant: University of Florida Research Foundation, Inc., Gainesville, FL (US)

(72) Inventors: Philip G. Koehler, Gainesville, FL (US); Roberto M. Pereira, Gainesville, FL (US); Christopher D. Batich, Gainesville, FL (US)

(21) Appl. No.: 18/751,835

(22) Filed: Jun. 24, 2024

Related U.S. Application Data
(62) Division of application No. 17/307,466, filed on May 4, 2021.
Application No. 17/307,466 is a continuation of application No. 16/097,934, filed on Oct. 31, 2018, now Pat. No. 11,026,424.
(60) Provisional application No. 62/341,382, filed on May 25, 2016.

(51) Int. Cl. A01N 43/40; A01M 1/20; A01N 25/04; A01N 25/10; A01N 53/00

(52) U.S. Cl. CPC A01N 43/40; A01M 1/2016; A01N 53/00; A01N 25/04; A01N 25/10

(57) ABSTRACT

Compositions, formulas, methods of making, mixing and applying insecticide formulations to different surfaces such as but not limited to interior surfaces of ovitraps, on walls and on chips and tiles to produce a texturized surface to allow for better transfer of the insecticidal active ingredients to insects, such as mosquitoes and the like, which land on or crawl on the surfaces, resulting in faster insect mortality rates. The texture of the insecticidal residue provides better transfer of the insecticidal active ingredients to insects that land on or crawl on the surface, resulting in faster insect mortality. The textured residue also enhances desirable surface characteristics for landing of mosquitoes and potentially other insects.

### CROSS-REFERENCE TO RELATED APPLICATIONS

This application is a divisional application of U.S. nonprovisional application Ser. No. 17/307,466 filed on May 4, 2021, which is a continuation application of U.S. nonprovisional application Ser. No. 16/097,934 filed on Oct. 31, 2018, which is a US national phase application of international application no. PCT/US2017/034500 filed on May 25, 2017, which claims priority upon U.S. provisional application Ser. No. 62/341,382 filed May 25, 2016. These applications are hereby incorporated by reference in their entirety.

### GOVERNMENT LICENSE RIGHTS

This invention was made with Government support under USDA-ARS contract 58-0208-3-001 awarded by the U.S. Department of Agriculture. The government has certain rights in this invention.

### BACKGROUND AND PRIOR ART

Ovitraps have been used over the years for the treatment of mosquitoes and the like. However, most treatments result in smooth surfaces which have limitations to both for the release of the insecticide and a surface for mosquitoes to land on and traverse.

Thus, the need exists for solutions to the above problems with the prior art.

### SUMMARY OF THE INVENTION

A primary objective of the present invention is to provide compositions, formulas, methods of mixing and applying insecticide formulations to different surfaces such as but not limited to interior surfaces of ovitraps, on walls and on chips to produce a texturized surface to allow for better transfer of the insecticidal active ingredients to insects, such as mosquitoes and the like, which land on or crawl on the surfaces, resulting in faster insect mortality rates.

A secondary objective of the present invention is to provide compositions, formulas, methods of mixing and applying insecticide formulations to different surfaces such as but not limited to interior surfaces of ovitraps, on walls and on chips to produce a texturized surface to enhance desirable surface characteristics for landing of mosquitoes and potentially other insects.

An insecticidal composition for treating surfaces, can include a texturizing agent, a polymer mixture for suspending the texturing agent within, and a solvent for dissolving the textured agent suspended in the polymer mixture, and wherein the composition is useful to form a texturized surface to treat insects, such as mosquitoes.

The texturizing agent can include fumed silica. The polymer can include an Iso-butyl-methacrylate. The solvent can include acetone. The insecticidal composition can further include Pyriproxyfen. The insecticidal composition can further include Permethrin.

A method of making a texturized surface with an insecticide composition, can include the steps of preparing an insecticidal composition mixture by mixing a texturing agent with a polymer and a solvent for dissolving the textured agent, and forming a texturized surface on an object.

The forming step can include spraying a surface of the object. The forming step can include painting a surface of the object. The forming step can include etching a surface of the object.

The forming step can include forming the texturized surface by injection molding the mixture with a plastic.

The object being treated can include an interior surface of an ovitrap. The object can include a surface of a chip. The object can include a ceramic tile surface.

Further objects and advantages of this invention will be apparent from the following detailed description of the presently preferred embodiments which are illustrated schematically in the accompanying drawings.

### BRIEF DESCRIPTION OF THE FIGURES

FIG. 1 is a graph showing percent of insect mortality versus brushed and sprayed surface insecticide treatments

FIG. 2 is a flow chart of the steps for preparation of the novel formulations.

### DESCRIPTION OF THE PREFERRED EMBODIMENTS

Before explaining the disclosed embodiments of the present invention in detail it is to be understood that the invention is not limited in its applications to the details of the particular arrangements shown since the invention is capable of other embodiments. Also, the terminology used herein is for the purpose of description and not of limitation.

In the Summary above and in the Detailed Description of Preferred Embodiments and in the accompanying drawings, reference is made to particular features (including method steps) of the invention. It is to be understood that the disclosure of the invention in this specification does not include all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

In this section, some embodiments of the invention will be described more fully with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art. Like numbers refer to like elements throughout, and prime notation is used to indicate similar elements in alternative embodiments. This application can be used with previous applications of the assignee that include U.S. patent application Ser. No. 15/048,604 filed Dec. 19, 2015, which is a Divisional of U.S. patent application Ser. No. 14/204,524, filed Mar. 11, 2014, now U.S. Pat. No. 9,295,246, which claims the benefit of priority to U.S. Provisional Patent Application Ser. No. 61/777,766 filed Mar. 12, 2013. The entire disclosure of each of the applications listed in this paragraph are incorporated herein by specific reference thereto.

The invention can be used with treating different objects such as ovitraps, and chips, and the like, referred to in the parent patent applications, in addition to ceramic tile materials, and plastics as described below.

The invention includes an insecticide formulation containing a texturizing agent (fumed silica) suspended in a mixture of a polymer (Isobutyl-methacrylate) dissolved in a solvent (acetone). When applied with a spray nozzle, the formulation dries rapidly over surface producing a texturized residue.

The texture of the insecticidal residue provides better transfer of the insecticidal active ingredients to insects that land on or crawl on the surface, resulting in faster insect mortality. The textured residue also enhances desirable surface characteristics for landing of mosquitoes and potentially other insects. The polymer both serves to support for the texturizing agent, and to control the release of the insecticide active ingredient, providing longer-lasting residues.

Tables 1 and 2 show insecticidal compositions for treating surfaces of objects with fumed silica. Table 1 and 2 have similar compositions with Table 1 additionally comprising Permethrin.

TABLE 1

| | | grams | | |
|---|---|---|---|---|
| | Component | w/acetone | Preferred | |
| Component | ID | For 1 liter | amnt | Range |
| Pyriproxyfen | 95737-68-1 | 0.084 | 0.01% | 0.10 to 0.005% |
| Permethrin | 52645-53-1 | 5.894 | 0.70% | 1.0 to 0.5% |
| Fumed Silica | 7631-86-9 | 8.415 | 1.00% | 3.0 to 0.5% |
| Polymer | 9011-15-8 | 42.073 | 5.00% | 7.0 to 1.0% |
| (Iso-buthyl- | | | | |
| methacrylate) | | | | |
| Acetone | 67-64-1 | 785.000 | 93.29% | 88.9 to 97.095% |
| | Total | 841.462 | 100.00% | |

TABLE 2

| | | grams | | |
|---|---|---|---|---|
| | Component | w/acetone | Preferred | |
| Component | ID | For 1 liter | amnt | Range |
| Pyriproxyfen | 95737-68-1 | 0.084 | 0.01% | 0.10 to 0.005% |
| Fumed Silica | 7631-86-9 | 8.352 | 1.00% | 1.0 to 0.5% |
| Polymer | 9011-15-8 | 41.760 | 5.00% | 7.0 to 1.0% |
| (Iso-buthyl- | | | | |
| methacrylate) | | | | |
| Acetone | 67-64-1 | 785.000 | 93.99% | 91.9 to 98.495% |
| | Total | 835.195 g | 100% | |

Tables 1 and 2 represent the formulations used in the tiles (formulation without the adulticide permethrin), and the formulation used in the ovitraps (DDALO, or 00-ZZZero) which contains both the larvicide (pyriproxyfen) and the adulticide (permethrin).

Each of the percent amounts referenced in Tables 1 and 2 can each be approximately those listed amounts and include those exact listed percent amounts.

Two different formulations can be necessary because the tiles only require the larvicide because they are added to bodies of water to prevent development of the mosquito larvae (which do not cause any problem in terms of disease transmission) into adult mosquitoes (which can transmit the diseases. The ovitraps are coated internally with the formulation containing both active ingredients because adult females mosquitoes that come in to lay eggs inside the traps are killed with the adulticide while any larvae that may develop in the water are killed by the larvicide before they become adults.

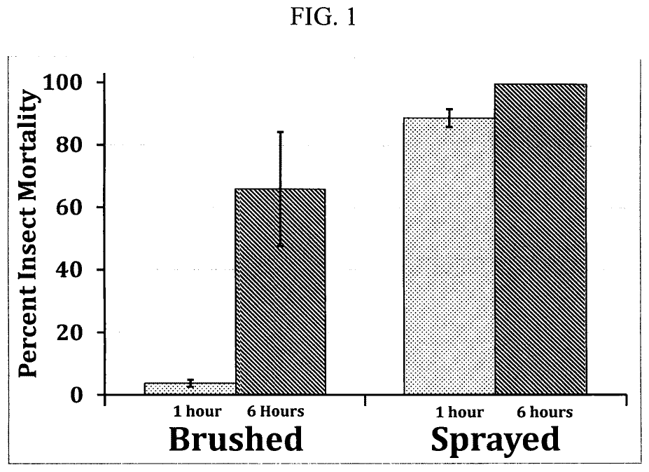

FIG. 1 is a graph showing percent of insect mortality versus brushed and sprayed surface insecticide treatments. FIG. 1 shows the importance of spraying the formulation as opposed to applying it by crushing or other method for deposition of the formulation on a surface. When spayed, the formulation dries quickly and forms a rougher deposit on the surface due to the quick volatilization of the carrier (acetone) and the retention of the silica particles on a structured polymer deposit. With sprayed formulation mortality occurs sooner (greater 1-h mortality), and reaches higher levels (Greater 6-h mortality).

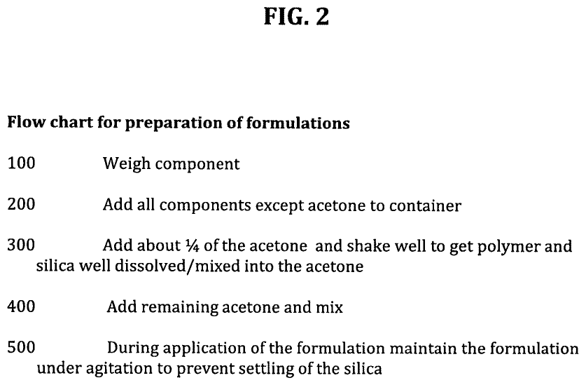

FIG. 2 is a flow chart of the five main steps for preparation of the novel formulations.
Step 1 (100), weigh component,
Step 2 (200) add all components except acetone to the container.
Step 3 (300) add about ¼ of the acetone and shake well to get polymer and silica well dissolved/mixed into the acetone.
Step 4 (400) add remaining acetone and mix.
Step 5 (500) during application of the formulation, maintain the formulation under agitation to prevent settling of the silica.

The texturized surface in a preferred embodiment can be used with mosquitoes. The microstructures and nanostructures of a mosquito's foot can have a length of about 2-3 uM, a width of about 1 u, and a thickness varying from about 200 nm to about 500 nm, with the diameter of the seta ranges from about 200 nm to about 250 nm. See Wu and Kong, Micronanostructures of the scales on a mosquito's legs and their role in weight support, Physical Review E 76, 017301, pages 1-4. The American Physical Society. 2007.

The invention can be used to form a texturized surface can include silica particles having structures below approximately 100 uM would be best to use (<approximately 0.10 mm). The subject invention structures were agglomerates of approximately 10 uM with substructures approximately 1 uM or less. In the opinion of the inventors, a very small roughness would be best. Fumed silica would be preferred particles to be used.

Additional materials which can provide such small features can further include carbon black and fine features on larger structures like cotton fibers or wood bark, or rice hulls.

Many methods can be used to produce the textured surface. Spraying and painting and brushing the surface with the composition mixture can be done. Spraying the inside of an ovitrap type container, or surface of a chip, and the like, with the solvent mix containing polymer and particles would be most likely to produce the finely textured surface.

Additionally, etching the surface with a plasma or corona discharge, or even an ozone exposure would create a rough surface. Still furthermore, sandblasting the surface can also be accomplished.

Sand blasting is one of several abrasive blasting methods where a hard material is rapidly driven against a softer material by use of a pressurized vehicle such as air or water. It causes removal and deformation of the soft material's surface layer. Metal, glass beads or ceramics can be used.

Additional methods such as but not limited to ion etching are also possible, and would require vacuums, and the like. For polymers like polylactic acid, a solvent such as chloroform may also be used to etch the surface. Molding the texturized surface can also be accomplished. For example, injection molding is often used to make containers, but more often injection blow-molding can be used. The later method uses air or nitrogen to expand the soft plastic, and does not put as much pressure on the surface as a mold would. Hence, particles incorporated in the plastic can be exposed to some extent on the inner surface. In some cases, they would be covered by a plastic layer and not have the very fine structure with features the size of a mosquito foot part. The utility would depend on particle loading, processing temperature and other factors.

With injection molding, the container or chip, and the like, can be made of many plastics, but the most common ones are very slowly degrading (polyethylene, polypropylene, polyethylene terephthalate, polyvinyl chloride or copolymers like EPDM).

Since it can be beneficial to have the device degrade when no longer effective or needed, one could make the bottle of a degradable plastic like poly-L-lactic acid (PLLA). This polymer is modifiable by mixing in other monomers (D-lactide, L-glycolide, caprolactone) or agents to speed or slow degradation like solid acids, bases or buffers.

Almost any solid or porous material can be able to carry a slow-release formulation.

Chips, such as but not limited to pebbles and the like, can be made of macroporous polymer beads or polystyrene or other polymers, porous ceramics, clays, cements or agglomerales or porous metals. Fiber mats, such as cloth, can also hold the polymer/larvicide composition for slow release applications.

Additionally, additives such as anti-oxidants, such as but not limited to Butylated hydroxytoluene (BHT) and Vitamine E (Alpha-Tocopherol or D-alpha-Tocopherol).

The additives would be used to prevent the breakdown of any of the active ingredients when the active ingredients are mixed or stored.

The terms “approximately” and “about” can be +/−10% of the amount referenced. Additionally, preferred amounts and ranges can include the amounts and ranges referenced without the prefix of being approximately.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

1. An article comprising a coating on at least one surface of the article, wherein the coating comprises (a) an insecticide active ingredient, (b) a texturizing agent, and (c) a polymer.

2. The article of claim 1, wherein the texturizing agent comprises fused silica.

3. The article of claim 1, wherein the insecticide active ingredient comprises pyriproxyfen, permethrin, or a combination thereof.

4. The article of claim 1, wherein the polymer comprises poly (isobutyl methacrylate).

5. The article of claim 1, wherein the coating further comprises an anti-oxidant additive.

6. The article of claim 5, wherein the anti-oxidant additive comprises butylated hydroxytoluene (BHT) or vitamin E.

7. The article of claim 6, wherein the vitamin E comprises alpha-tocopherol or D-alpha-tocopherol.

8. The article of claim 1, wherein the texturizing agent comprises fused silica and the polymer comprises poly (isobutyl methacrylate).

9. The article of claim 1, wherein the coating consists of an insecticide active ingredient, a texturizing agent, a polymer, and optionally an antioxidant.

10. The article of claim 1, wherein the coating consists of an insecticide active ingredient, fused silica, poly (isobutyl methacrylate), and optionally an antioxidant.

11. The article of claim 1, wherein the article comprises a plastic material.

12. The article of claim 11, wherein the plastic comprises polyethylene, polypropylene, polyethylene terephthalate, polyvinyl chloride, poly-L-lactic acid, poly-L-lactide-co-glycolide, or polystyrene.

13. The article of claim 1, wherein the article comprises a ceramic, clay, or cement.

14. The article of claim 1, wherein the article comprises a bead, a chip, a tile, a fiber mat, or an ovitrap.

15. A coated article produced by the method comprising applying to at least one surface of the article a composition comprising (a) an insecticide active ingredient, (b) a texturizing agent, (c) a polymer, and a solvent.

16. The article of claim 15, wherein the solvent comprises acetone.

17. The article of claim 15, wherein the texturizing agent comprises fused silica.

18. The article of claim 15, wherein the insecticide active ingredient comprises pyriproxyfen, permethrin, or a combination thereof.

19. The article of claim 15, wherein the polymer comprises poly (isobutyl methacrylate).

20. The article of claims 15, wherein the composition is sprayed on the at least one surface of the article.
